(19) United States
(12) Patent Application Publication
(10) Pub. No.: US 2013/0260871 A1
(43) Pub. Date: Oct. 3, 2013

(54) VARIOUS CONTROL ELEMENTS IN A HYBRID GAME

(71) Applicant: Gamblit Gaming, LLC, Glendale, CA (US)

(72) Inventors: Miles Arnone, Sherborn, MA (US); Eric Meyerhofer, Pasadena, CA (US)

(21) Appl. No.: 13/900,363

(22) Filed: May 22, 2013

Related U.S. Application Data
(63) Continuation of application No. PCT/US12/50204, filed on Aug. 9, 2012.
(60) Provisional application No. 61/574,753, filed on Aug. 9, 2011.

(51) Int. Cl. G07F 17/32

(52) U.S. Cl. CPC G07F 17/3202
USPC 463/25

(57) ABSTRACT

Methods and systems for a game having a gambling game portion and an entertainment game portion are provided. Elements of the game, when acted upon by a player of a game, trigger a wager that is made within the gambling game portion of the game. Once acted upon by the player, element may or may not be restored within the entertainment game portion to the element's pre-acted upon form.

### CROSS REFERENCE TO RELATED APPLICATIONS

This application is a continuation of Patent Cooperation Treaty Application No. PCT/US12/50204, filed on Aug. 9, 2012, which claims the benefit of U.S. Provisional Application No. 61/574,753, filed Aug. 9, 2011, and is related to PCT patent application PCT/US11/26768, filed Mar. 1, 2011, U.S. Provisional Patent Application 61/459,131, filed Dec. 6, 2010, and U.S. Provisional Patent Application 61/460,362, filed Dec. 31, 2010, the contents of each of which are hereby incorporated by reference as if stated in full herein.

### BACKGROUND

1. Field

Various embodiments of the present invention relate generally to a game of chance and more specifically to the methods and apparatus to create and operate the hardware and software constituent components in the context of a game of chance environment.

2. Background

The gaming machine manufacturing industry provides a variety of gaming machines for the amusement of gambling players. An exemplary gaming machine is a slot machine. A slot machine is an electro-mechanical game wherein a random number generator determines the outcome of a gambling game, and this, coupled with the betting decisions of a player, results in a specific payout. Slot machines are usually found in casinos or other more informal gaming establishments.

Slot machines have a simple implementation of a game of chance wherein a player of the slot machine provides credits that the player wagers by manipulation of the slot machine's various buttons, levers, etc. The slot machine takes the wager and calculates a result that is then presented to the player via an electromechanical or video display.

Games involving random outcomes for gambling games and games having a player skill component have been combined. For example, U.S. Patent Application Publication No. 2005/0239538 A1 discloses a gaming apparatus that includes a video game unit, a gambling game unit and a game interface unit. The game interface unit controls the playing of the video game unit based on the playing of the gambling game unit. The gaming apparatus is further configured to pay winnings to a player playing the gaming apparatus based on signals from the game interface unit.

U.S. Patent Application Publication No. 2008/0108425 A1 discloses a gaming device that enables players to play an interactive game and make wager components that occur during the interactive game, where the wagering outcome for each of the wager components is independent from the interactive game. The interactive game is a skill based game initiated by the player. The player funds the gaming machine and during play of the interactive game, upon the occurrence of a wager triggering event, the gaming machine causes a wagering event to occur. The wagering event includes a placement of a wager component and a random determination of a wagering outcome for that wagering event.

U.S. Patent Application Publication No. 2010/0056247 A1 discloses a gaming device that includes a game or game event having an element of strategic skill. The game or game event enables a player to make strategic choices or decisions that have a direct impact on the player's chance of obtaining one or more outcomes or awards in a play of a game.

U.S. Pat. No. 7,326,115 discloses a gaming machine having a first interactive game requiring one or more player inputs. The player inputs result in one or more outcomes. The outcomes do not result in a monetary or other valuable award provided to the player. Rather, a second wagering game is always provided to the player where the player can obtain or has a chance to obtain a monetary or other valuable award.

U.S. Patent Application Publication No. 2009/247272 discloses a gaming machine having a display which arranges a plurality of symbols in a matrix of arrangement areas. The gaming machine provides a base game and a plurality of feature games using the display by rearranging the plurality of symbols in the arrangement areas in the base game, awards a base payout in accordance with a relation among the symbols rearranged in the arrangement areas, awards a feature game which corresponds to the number of predetermined symbols rearranged in the arrangement areas, performs the feature game and awards a bonus payout in accordance with a result of the feature game.

U.S. Pat. No. 5,718,429 discloses a game in which people may place a stake in a casino game and win a cash prize in a skill game. Stakes in the casino game are placed with chips, which may be purchased in exchange for the services of conducting the casino game. A winning stake is rewarded with a token, rather than with money. A token may be exchanged for an opportunity to demonstrate a skill in the skill game. Those that successfully demonstrate the skill are awarded cash or other prize.

U.S. Pat. No. 5,785,592 discloses an interactive target game system for one or more players which may include a vehicle on which a player may ride over a predetermined pathway in a defined area (or the player may walk.) The game includes at least one designator, holdable by a player for aiming at a target and operating to simulate shooting at the target, and at least one target disposed in proximity to the pathway. An indicator device responds to the designator being accurately aimed at the target and operated, for producing an indication of a “hit” or score. The targets may include opportunities to play a game of chance.

U.S. Patent Application Publication No. 2004/0121839 discloses a gaming apparatus operable by a player to simulate a card game in which a hand of cards is dealt to the player. The gaming apparatus displays an image of a player hand including at least one obscured card when first dealt, and modifies the display image data in accordance with player instructions received by the input means, to cause the created image to reveal each obscured card in a manner determined by the player.

### SUMMARY

Various embodiments of the present invention are a form of a gaming machine, designed for use in a physical or virtual casino environment, which provides players an environment in which to play for cash, either against the casino and/or each other in a regulated manner, in a fashion mimicking video entertainment games which are popular today (such as those executing on a PlayStation® or Xbox® and including multi-player and massively multi-player games played over the Internet).

Many embodiments provide an enticing method of gaming to the players who expect a high level of entertainment content in their gaming experience compared to the relatively simple game methods in use today. In some embodiments, a method is provided for a random outcome independent of player skill while ensuring that the user's gaming experience (as measured by obstacles/challenges encountered, time of play and other factors) is shaped by the player's skill. In numerous embodiments, the method also provides for players to gain entry into subsequent competitions through the accumulation of “game world credits” that accrue as a function of their demonstrated skill at the game. These competitions, the inclusion of which is not a mandatory component of the invention's implementation, would pit individual players or group of players against one another and/or against the casino to win prizes based upon a combination of chance and skill. These competitions may be either asynchronous events, whereby players participate at a time and/or place of their choosing, or they may be synchronized events, whereby players participate at a specific time and/or venue.

In various embodiments, in a typical gaming environment application, these games are installed and connected by a network on a casino floor, and/or be connected by various means to a wide area network to a server conglomeration which would control various aspects of the gaming environment, provide gaming regulatory body monitoring, financial accounting and forms of frequent player monitoring for marketing purposes.

In many embodiments, such a gaming system is implemented over a wide area network such as the Internet.

### BRIEF DESCRIPTION OF THE DRAWINGS

FIG. 1 is a diagram of a gaming system in accordance with exemplary embodiments.

FIG. 2 is a diagram of a sequence of operations in accordance with exemplary embodiments.

FIG. 3 is a diagram of a process of using enabling elements in accordance with exemplary embodiments.

FIG. 4 is a diagram of a process of using actionable elements in accordance with exemplary embodiments.

FIG. 5 is a diagram of a process of revealing actionable elements in accordance with exemplary embodiments.

FIG. 6 is a diagram of a process of using actionable and enabling elements in accordance with exemplary embodiments.

FIG. 7 is another diagram of a process of using actionable and enabling elements in accordance with exemplary embodiments.

FIG. 8 is another diagram of a process of using actionable and enabling elements in accordance with exemplary embodiments.

FIG. 9 is another diagram of a process of using actionable and enabling elements in accordance with exemplary embodiments.

FIG. 10 is a diagram of a process using a transformation function in accordance with exemplary embodiments.

FIG. 11 is a hardware architecture diagram of a processing apparatus in accordance with exemplary embodiments.

### DETAILED DESCRIPTION

Methods and systems for a game of a chance, influenced by components of the player's skill, allowing a player to compete directly with a gaming machine device are provided. The methods and systems provide players a rich (i.e. akin to leading home- and arcade-based video games) single-player, multi-player cooperative and/or head to head environment in which the participant(s) win cash and credits as a result of their play activity within the environment, based on the wagers which they make entering and playing the game

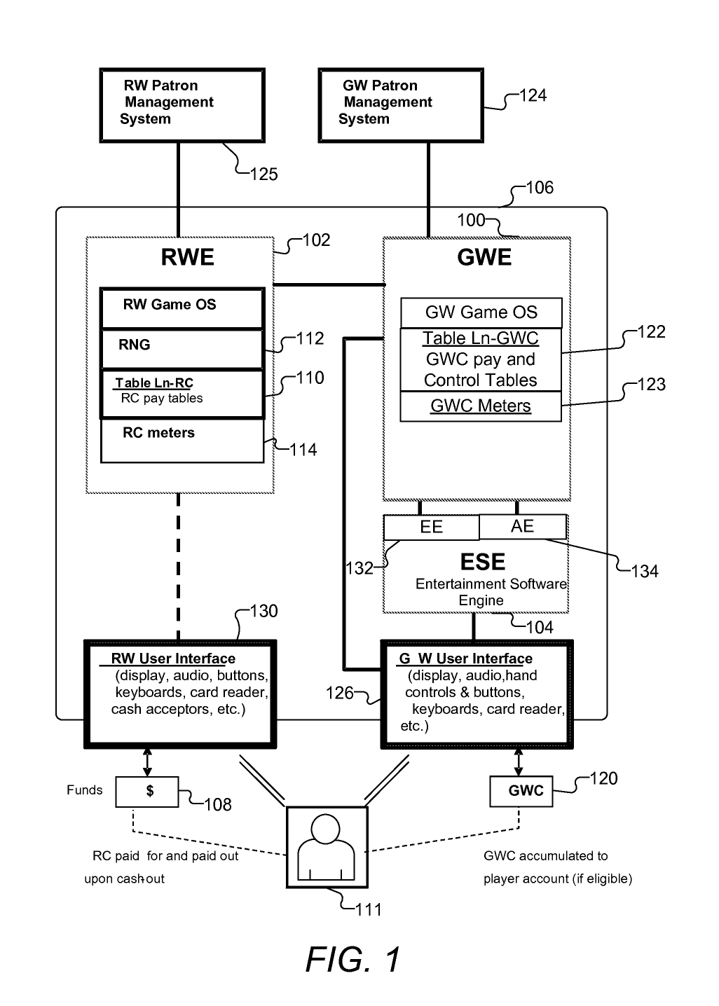

FIG. 1 is a diagram of a gaming system in accordance with exemplary embodiments. FIG. 1 generally illustrates the architecture of the system and the interaction between three systems: a game world engine (GWE) 100, a real world engine (RWE) 102 and an entertainment software engine (ESE) 104, the electrical and software system which controls the playing of video games. The combination of an RWE, a GWE and an ESE are included in a hybrid game 106.

In many embodiments, a game world (GW) includes an entertainment game portion of a hybrid game and includes the information typically associated with a virtual interactive entertainment environment, including its game controlled entities or player characters, progress points and scores. For example, a typical game played on a Sony PlayStation® console could be thought of as being included in a GW.

A real world (RW) portion of a hybrid game is a gambling game portion, which may or may not include an entertainment portion of its own, but whose operation is enabled by real funds, accretes and declinates real gambling credits based on random gambling outcomes, and whose gambling proposition is typically regulated by gaming control bodies. For example, the fundamentals of the mechanisms of play of a slot machine could be thought of as included in a RW.

In some embodiments, real world credit (RC) 108 are credits that are analogous to slot machine game credits which are entered into a RW game by the user, either in the form of currency or electronic funds. In many embodiments, RCs are decremented or augmented based on the outcome of a random number generator according to a Table Ln-Rc 110 real world credits pay table, independently of player skill. In numerous embodiments, a certain amount of RC are required to enter higher ESE 104 game levels. In some embodiments, RC can be carried forward to higher game levels or paid out if a game cash out is opted for by a player 111. The amount of RC required to enter a specific level of the game “Level n” need not be the same for each level.

A level n real-world credit pay table (Table Ln-Rc) 110 is a table and/or algorithms that may exist, and may be used in conjunction with a random number generator (RNG) 112 to determine the RC earned as a function of game play and is analogous to the pay tables used in a conventional slot machine. In many embodiments, Table Ln-Rc payouts are independent of player skill. There may be one or a plurality of Table Ln-Rc pay tables included in a game design.

The RWE 102 is the operating system for the RW portion of the game and controls and operates the gambling proposition. The RWE is a portion of a hybrid game which manages the RW portion of the game and includes the mechanical, electronic and software components to: (a) provide control of the RW portion of the game, (b) include Table Ln-RC and to take input from this table to affect the play of the RW portion of the game, (c) couple to the GWE to communicate the amount of RC available on the game, (d) communicate other metrics of wagering to the GWE, (e) accept input from the GWE as to the amount of RC in play, (f) accept signaling from the GWE in order to trigger the actual execution of an RW gambling play, (g) include various audit logs and activity meters, (h) couple to a centralized server for exchanging various data related to accounting of the gambling proposition, the player and their wagering activities on the game.

The RWE includes an RNG 112 which is a software and/or hardware algorithm and/or process which is used to generate random outcomes, pay tables (Table Ln-RC) 110, meters 114 and other software constructs used by the game of chance to offer a fair and transparent gaming proposition, and to include the auditable systems and functions for the game to obtain gaming regulatory body approval. The RWE encompasses many components of a slot machine. A slot machine is typically an electro-mechanical game wherein a random number generator determines the chance of outcome of a game, and coupled with the betting decisions of a player, a gambling outcome result. Slot machines are usually found in casinos or other more informal gaming establishments.

In some embodiments, the RWE 102 does not include an entertainment front end. The RWE accepts a trigger to run the gambling proposition in response to actions taken by the player in the GW as conveyed by the ESE 104 to the GWE 100, or as triggered by the GWE based on its algorithms, background to the overall game from the player's perspective, but would provide information to the GWE to expose the player to certain aspects of the gaming proposition, such as odds, amount of RC in play, amount of RC available, etc. In some embodiments, an RWE accepts modifications in the amount of RC wagered on each individual gambling try, or the number of games per minute the RWE would execute, entrance into a bonus round, and other factors, all the while these factors and the choices from the player's perspective taking a different form than that of a typical slot machine. An example of a varying wager amount that the player would choose might be that they have decided to play with a more powerful controlled entity in the game, or having a more powerful gun, a better car, etc. These choices would increase or decrease the amount wagered per individual RWE gambling game, in the same manner that a standard slot machine player may decide to wager more or less credits for each pull of the handle. The RWE would communicate a number of factors back and forth to the GWE, discussed below, via their interface, such increase/decrease in wager being a function of the player's decision making as to their operational profile in the GW (i.e. power of the controlled entity, gun selection, car choice, etc.). In this manner, the player is always in control of the per game wager amount, with the choice mapping to some parameter or component which is applicable to the GW experience that is the entertainment piece for the game. An example of the RWE operation are a game of chance running, say every 10 seconds, the amount wagered being communicated from the GWE as a function of choices the player makes in the operation profile in the GW such as those cited above.

In some embodiments, the RWE 102 communicates with the player 111 using an RW user interface 130. The RW interface may include various devices such as a display, audio output, buttons, keyboards, card readers, cash acceptors, etc. The player may use the RW interface to pay for credits using vouchers or currency, receive cashouts of credits, identify themselves to the patron management systems 124 and/or 125, receive an indication of the current level of credits that the player has with the hybrid game, etc.

Game world credits (GWCs) are player points earned or depleted as a function of player skill, i.e. as a function of player performance in the context of the game. In many embodiments, GWC is analogous to the “score” in a typical video game. Each game has a scoring criterion, embedded within a Table Ln-GWC 122 that reflects player performance against the goal(s) of the game. In numerous embodiments, GWC can be carried forward from one level of game play to another, and ultimately paid out in various manners such as directly in cash, or indirectly such as earning entrance into a sweepstakes drawing, or earning participation in, or victory in, a tournament with prizes. In some embodiments, GWC may be stored on a player tracking card or in a network-based player tracking system and the GWC is attributed to a specific player.

A level n game world credit pay table (Table Ln-GWC) 122 is a table and/or algorithms that determines the GWC earned as a function of player skill in the nth level of the game. The payouts governed by this table are dependent upon player skill and game play at large and may or may not be coupled to a random number generator.

In some embodiments, GWC determines levels in a game. In numerous embodiments, any player may begin game play at level 1. Entry to level 1 requires loading of RC into the game. There is no GWC required to enter level 1. Players can re-enter the game at level ‘n’ if they have accumulated adequate GWC to enter the level. A specific GWC hurdle is established for each Level, with GWC≧0 allowing entry into level 1. The GWC hurdle for each level n may be the same or can increase as a function of each level. In some embodiments, when a certain level of GWC is obtained by the player, game play proceeds to a non-re-entrant level Level B1 commences a series of levels from B1 to Bn where re-entry is no-longer possible and where game play may be exclusively skill based or a combination of skill and chance. In many embodiments, game-play continues as the player advances through the B levels until such time as the player either cashes out their RC, all RC has been consumed, a player has exhausted their GWC through play, or a player has exhausted their game controlled entity's lives, energy or other element required for the controlled entity to survive within the game environment. In some embodiments, a player cashing out in the B levels can re-enter the game at the highest re-entrant level, “level n”. In some embodiments, there are additional levels are non-re-entrant levels that are only accessed by completing a level B(n−1) with adequate GWC.

In some embodiments, an enabling element (EE) is a GW element that is consumed or accumulated in the context of the game, such as ammo, health points, potions, fuel, etc. In numerous embodiments, currency includes EE, GWC, RC, other entertainment game elements.

FIG. 1 also includes the GWE 100, the gaming world operating system. The GWE is a portion of the hybrid game which primarily manages the GW portion of the game and includes the mechanical, electronic and software components to: (a) provide control of the GW portion of the game, (b) include Table Ln-GWC 122 and to take input from this table to affect the play of the GW portion of the game, (c) couple to the RWE 102 to determine the amount of RC available on the game and other metrics of wagering on the RW portion of the game, and potentially affect the amount of RC in play on the RWE, (d) include various audit logs and activity meters 123, (e) couple to a centralized server 124 for exchanging various data related to the player and their activities on the game, (f) couple to the ESE 104.

One of the GWE's 100 functions is to manage the overall game operation, with the RWE 102 and the ESE 104 effectively being support units to the GWE. In some embodiments, no operation of the GWE affects the RWE's gambling operation except for player choice parameters that are allowable in slot machines today, such as the wager amount, how fast the player wants to play (by pressing a button or pulling the slot's handle), agreement to wager into a bonus round, etc. In this sense, the RWE provides a fair and transparent, non-skill based gambling proposition co-processor to the GWE. The communication link shown between the GWE and the RWE in FIG. 1 is primarily for the purposes of GWE obtaining information from the RWE as to the amount of RC available on the RW portion of the game, and status operation of the RWE (such as on-line or tilt), and for the GWE to communicate to the RWE the various gambling control factors which the RWE uses as input, such as the number of RC consumed per game or the player's election to enter a jackpot round.

In some embodiments, the GWE 100 connects to the player's user interface 126 directly, as this may be used to communicate certain GW club points, player status, control the selection of choices and messages which a player may require in order to adjust their GW experience or understand their gambling status in the RWE 102.

In FIG. 1, the GWE 100 also connects to the ESE 104. The ESE manages and controls the visual, audio and player control entertainment for the GW game. In many embodiments, the ESE accepts input from a player through a set of hand controls and outputs video, audio and/or other sensory output to a user interface. A PC, Nintendo WHO, Sony PlayStation® or Microsoft Xbox® running a specific game program (e.g. a version of Madden Football '10®) are examples of an ESE. The ESE exchanges data with and accepts control information from the GWE.

The ESE 104 operates mostly independently from the GWE 100, except that via their interface, the GWE may send certain GW game control parameters to the ESE to affect its play, such as what level of controlled entity to be using, changing the difficulty level of the game, changing the type of gun or car in use, requesting potions to become available or to be found by the controlled entity, etc. The ESE accepts this input from the GWE, makes adjustments, and continues the play action all the while running seamlessly from the player's perspective. The ESE's operation is mostly skill based, except for where the ESE's algorithm may inject complexities into the game by chance in its normal operation to create unpredictability in the GW game and the like. Utilizing this interface, the ESE may also communicate player choices made in the game to the GWE, such as selection of a different gun, the player picking up a special potion in the GW environment, etc. The GWE's job in this architecture, being interfaced thusly to the ESE, is to allow the transparent coupling of entertainment software to a fair and transparent random chance gambling game, providing a seamless perspective to the player that they are playing a typical popular entertainment and skill based game. For example, the ESE in this application could be used to enable a wide range of games including popular titles from arcade and home video games (e.g. Gears of War, Time Crisis, Madden Football, etc.). Providers of such software would provide the previously described interface by which the GWE could request amendments to the operation of the ESE software, in order to provide the seamless and sensible operation of the invention as both a RW gambling and entertainment machine.

In numerous embodiments, a video game style gambling machine is implemented, where the gambling portion of the game (i.e. RWE 102 and RC 108 of FIG. 1) is not player skill based, while at the same time allows players to use their skills to earn club points which an operator of a casino, such as an operator of a gaming establishment in either one or a plurality of locations where people go to play a gambling games of chance whether online or land-based, can translate to rewards, tournaments opportunities and prizes for the players. The actual exchange of monetary funds earned or lost directly from gambling against a slot machine is preserved, while at the same time a rich environment of rewards to stimulate “gamers” can be established. In some embodiments, a casino operator may operate other gambling operations, including but not limited to a wide area network gaming franchise, a gaming route, or other gambling business be it a physical manifestation in the case of a casino or virtual in the case of an internet gambling operation.

In many embodiments, a hybrid game leverages very popular titles with “gamers” and provides a sea change environment for casinos to attract players with games that are more akin to the type of entertainment which a younger generation desires.

In many embodiments, players use their skill towards building and banking GWC which in turn could be used to win tournaments and various prizes as a function of their “gamers” prowess.

In some embodiments, the underlying changes to the aforementioned entertainment software (Gears of War, etc.), are minimized for the entertainment game to operate within the gaming construct, thus making a plethora of complex game titles and environments, rapid and inexpensive to deploy in a gambling environment.

Various hybrid games are discussed in Patent Cooperation Treaty Application No. PCT/US11/26768, filed Mar. 1, 2011, entitled “ENRICHED GAME PLAY ENVIRONMENT (SINGLE and/or MULTI-PLAYER) FOR CASINO APPLICATIONS” and Patent Cooperation Treaty Application No. PCT/US11/63587, filed Dec. 6, 2011, entitled “ENHANCED SLOT-MACHINE FOR CASINO APPLICATIONS” each disclosure of which is hereby incorporated by reference in its entirety.

In many embodiments of a hybrid game, the functioning of a hybrid game uses enabling elements (EE) 132 and their interoperability with the hybrid game. EEs for a hybrid game are typically some consumable commodity and/or accumulating element in game context to play and operate controlled entities or characters or take actions in the game space of the interactive entertainment game. A non-exhaustive list of examples of EE includes: weapons ammunition, health points in a fighting game, potions in the case of a fantasy game, fuel in the case of a driving game, time in the case of a game where one races against the clock to achieve some objective, armies in the case of a military strategy game, or downs in the case of football. The nature of EE is a function of the type of entertainment game executed on the ESE and its structure. It is contemplated that the consumption of EE in the process of playing the ESE entertainment game would trigger gambling plays on the RWE portion of the hybrid game. In the hybrid game, it is also possible that the events of or acts of accumulation of EE in the entertainment game might also trigger RWE gambling plays in the same manner that consumption of EE would. This is to say that games could use either EE consumption, EE accumulation or both events to trigger RWE wagers. The correlation of what events resulting in the accumulation or consumption of EE might trigger RWE plays, and when, and the amount of RC wagered as a result of these events, would be a function of algorithms and formulae operating within the GWE and the hybrid game. It should be understood that as consistent with hybrid game methods that other triggers for RWE plays other than EE consumption or accumulation could be possible.

Another type of element that may be used in the hybrid game construct and its interoperability of credit exchange and deployment is called an actionable element (AE) 134. Like EE, an AE can initiate a gambling game by committing RC to the gambling proposition within the RWE. Unlike an EE, however, which is consumed or accumulated, an AE may not be expressly consumed or accumulated. AEs, instead, may be tied to specific player decisions or player directed actions that are undertaken in the context of the entertainment game, the outcome of those decisions or actions, or a game event or milestone points, or the transpiring of real or virtual game time in the process of playing the entertainment game. AEs, are constructs within the GW, not the physical world (PW), meaning the actual world with its real people, places, events, etc. The PW would be different than the GW. The PW would include the RW as well. However, AEs, are affected by PW decisions or actions subject to various formulae and algorithms as to whether the PW action or decision causes the AE to transpire.

There are a number of possible classes and examples of AE, namely:
1. Transpiring of a “meter” in the game space. Some examples being:
   every 10 steps taken by a controlled entity
   10 minutes of game world time (virtual) elapsed
   5 minutes of physical world time elapsed in the physical world
   Walking or traveling past a location or special point
2. GW Controlled Entity decisions directed by the PW player, random. This class of AE is that of decisions made by the GW Controlled Entity in the GW space as directed by the PW player, and are purely random style decision. Each decision in the tree would have some finite chance of success and conversely, failure or have different outcomes. Some examples being:
   Opening one door or another
   Choosing a sailing ship to board
   Picking up one of three magic rings
   Choosing a floor on the elevator in an unknown building
   The decision to throw virtual dice in GW
3. GW Controlled Entity decisions directed by the PW player, knowledge based. This class of AE is that of decisions made by the GW Controlled Entity in the GW space as directed by the PW player, and are based to some degree on knowledge the player may have about the situation or choices. Each decision in the tree would have some finite chance of success and conversely, failure or have different outcomes. Some examples being:
   Direct game resources to take a strategic hill or building in a combat game
   Selection of a particular airplane to fly. One airplane better than another for the purpose.
   Choosing one weapon or another in a 1^{st} person shooter game
   Selecting one football player over another when picking a team
   Choosing one club over another in a golf game
   Selecting one of a number of possible answers to a trivia question in a trivia game.
   Submitting an answer—not from a predetermined list of possible answers—to a trivia question in a trivia game
   The act of drawing a picture on the screen during a player's turn in a Pictionary-like game
   Selection of a type of troop, armor unit or artillery piece in a war game
   Selection of a type of armor for a character to wear in a fantasy game
   The placement of a hotel on a property in a Monopoly game
   The selection of which property, housing or hotels to mortgage in a Monopoly game when in financial trouble.
4. Actions conducted by the player's GW Controlled Entity in the game space which are impacted by the GW Controlled Entity game characteristics. Some examples being:
   Attempting to pick a lock to open a treasure chest in a fantasy game. The success or failure in the attempt being a combination of one or more of the following: a character's dexterity, their strength, their knowledge, an RNG outcome.
   Releasing a player's battleship to attack another warship, the success of the battle being a combination of one or more of the following: the battleship's armaments, its ammo, seaplanes and armor rating, an RNG outcome.
5. Outcomes of player directed decisions. Some examples being:
   Whether or not a strategic point was taken in a combat game
   Whether or not a treasure chest opened after an attempt at picking the lock
   Whether or not a character survived the jump from a cliff
   Whether or not a plane survived a stunt maneuver
   Whether a motorcycle cleared the line of trucks between the jump ramps
   Whether or not a fielded football team won the game or not
   The outcome of a the virtual dice of a GW dice throw
   Whether or not the answer provided to a trivia question was correct
   Whether or not the game, or a 3^{rd} party, was able to identify the picture being drawn by the player in a Pictionary-like game within an allowed time frame.

Note that the classes and examples of AE given above are non-exhaustive and intended to serve to illuminate the nature of AE. Other AEs may be possible within the general decision given above.

As stated earlier, each AE or AE outcomes listed above may be capable of triggering a RWE wager of varying RC amounts, and the wager, in some embodiments, also being configured as to the selection of the Table Ln-Rc or other RWE parameters. Various embodiments also subsume the prospect that a free bet may be made available for the player. That is to say, in any of the foregoing examples, a wager of 5 RC (for example), could also be a wager of 5 FPRC. “FPRC” means 5 Free Play Real Credits. The mechanism here is that a player wouldn't be charged for 5 FPRC wager, but such a wager, charged off to the casino or free wager provider, would be placed for the player in the RWE.

The concept of AE also subsumes player directed actions (one action or a chain of actions) that trigger gambling in the context of specific objects within the GW. Some examples being:
A character opens a treasure chest. The treasure chest has associated with it a bonusing round of one type or the other, or a prize, a wager, or a specific gambling game. By virtue of opening the treasure chest, the bonus is awarded, a bonusing round entered or a gambling game initiated, at least one of the outcomes of which is failure (e.g the chest is empty, the character is killed by a poisoned dart, etc.). The AE in this case is the opening of the chest, which triggers a RWE related event, the context of which is conditioned by the object acted upon, namely the treasure chest.
A player's character seeks and opens a treasure chest after being informed of its existence somewhere in the GW. This example is similar to the above, but includes a more extensive causal chain of events. AE need not be a single action or event.
A player's character drinks a potion. The potion has associated with it a bonusing round of one type or the other, or a prize, a wager, or a specific gambling game. By virtue of drinking the potion, the bonus is awarded, a bonusing round entered or a gambling game initiated, at least one of the outcomes of which is failure (e.g the character is killed by the potion or loses health points, etc.). The AE in this case is the drinking of the potion, which triggers a RWE related event, the context of which is conditioned by the object acted upon, namely the potion.

A non-exhaustive list of examples of the application of AE would therefore be:
in a 1st person shooter game, reaching a rally point objective (the AE) would cause 5 RC to be bet in a gambling game with certain odds.
in a fantasy game, each time the player's character opens a door (the AE) a wager of 2 RC is initiated.
In a murder mystery game in the proverbial mansion, each 1 hour after midnight of game world time that passes that the character survives (the AE), a 10 RC wager is initiated.
In a maze game, each 10 minutes (the AE) the player uses in navigating the maze results in a 3 RC wager with certain odds.
In a Monopoly Game, each time the player passes GO, (the AE), a 5 RC wager is initiated.
In a travel game, each point of interest reached (the AE) results in a 6 RC wager.
In a Scrabble Game, each time tiles are placed for a word using the player's knowledge resulting in a Double Word score, a 4 RC wager is initiated on a double odds pay table.
In a trivia game, each time the player submits an answer to a question, a 3 RC wager is initiated.
In a Pictionary-like game, each time the player commences drawing a picture, a 2 RC wager is initiated.

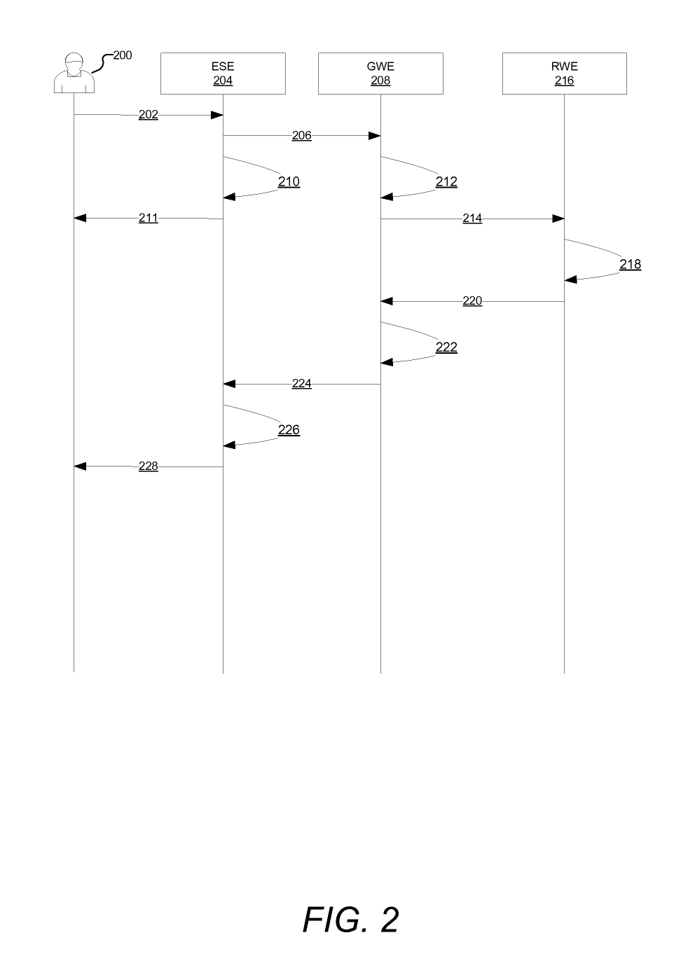

Referring now to FIG. 2, FIG. 2 is a diagram of a sequence of operations in accordance with exemplary embodiments. During operation of numerous embodiments of a hybrid game, a player 200 interacts (202) with game world elements of an interactive entertainment game hosted by an ESE 204 via a user interface (not shown). The ESE receives the user interactions and sends (206) them to a GWE 208 as player actions within the context of the interactive entertainment game of the ESE. The ESE 204 also uses the player actions to generate (210) a portion of the entertainment game for presentation (211) to the player 200.

The GWE 208 determines (212) from the player interactions with the entertainment game elements whether or not a gambling game should be initiated or triggered on an RWE 216. If a gambling game is to be triggered, the GWE triggers (214) a gambling game on the RWE. The RWE executes (218) the gambling game using an RNG and tables or the like to generate a gambling outcome. The RWE sends (220) the gambling outcome to the GWE.

The GWE 208 determines (222) from the gambling outcome whether or not elements of the interactive entertainment game should be updated to reflect the gambling outcome. If elements of the entertainment game are to be updated, the GWE sends (224) an update to the ESE 204. The ESE uses the updates from the GWE to generate (226) additional presentations for the user to reflect the elements that were updated at the request of the GWE and presents (228) that updated presentation to the player 200.

Various embodiments include the logic and systems to initiate wagers of varying types and amounts, based on an accumulation of one or a plurality of EE types.

In numerous embodiments, AEs or an AE, of one or a plurality of types of AE, transpire causing a wager of a certain amount of RC in a type of wagering proposition, where the type of AE is the transpiring of a game meter tick, and where the tick is an increment of elapsed physical time which has elapsed.

In some embodiments, a hybrid game includes AEs or an AE, of one or a plurality of types of AE, where transpiring of an AE causes a wager of a certain amount of RC in a type of wagering proposition, where the type of AE is the transpiring of a game meter tick, and where the tick is an increment of elapsed GW context time which has elapsed.

In various embodiments, a hybrid game includes AEs or an AE, of one or a plurality of types of AE, where transpiring of an AE causes a wager of a certain amount of RC in a type of wagering proposition, and the type of AE is the transpiring of a game meter tick, and the tick is a GW context distance traveled, a destination or milestone reached or arrival at a destination or location.

In many embodiments, a hybrid game includes AEs or an AE, of one or a plurality of types of AE, where transpiring of an AE causes a wager of a certain amount of RC in a type of wagering proposition, where the type of AE is a decision made by the player directing their resource(s) within the GW.

In some embodiments, a hybrid game includes AEs or an AE, of one or a plurality of types of AE, where transpiring of an AE causes a wager of a certain amount of RC in a type of wagering proposition, and the type of AE is the GW outcome of a decision made by the player directing their resource(s) within the GW.

In numerous embodiments, a hybrid game includes AEs or an AE, of one or a plurality of types of AE, where transpiring of an AE causes a wager of a certain amount of RC in a type of wagering proposition, and the type of AE is the GW action(s) of a player's resource(s) within the GW.

In many embodiments, transpiring of an AE affects any combination of one or a plurality of RC, EE and GWC.

In some embodiments, wagers of varying types and amounts are initiated, based on an accumulation or consumption of one or a plurality of GWC types.

In numerous embodiments, the hybrid game includes one or more transformation functions for the purposes of conditioning PW player actions and their correlation to AEs in the game space, where the conditioning may be a function of EE, an RNG outcome, GW character characteristics, casino modifiers, etc. or a combination of such factors.

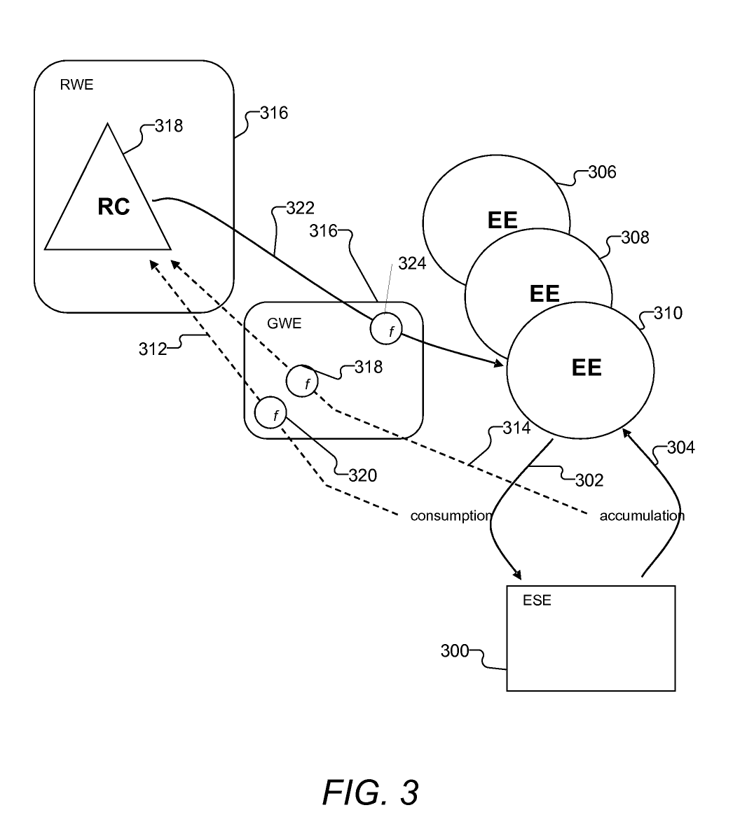

FIG. 3 is a diagram of a process of using enabling elements in accordance with exemplary embodiments. FIG. 3 illustrates the relationship of EE consumption and accumulation in some embodiments of a hybrid game construct. In the figure, events in an ESE 300 entertainment/skill game would cause either consumption (302) or accumulation (304) of one or a plurality of EE, such as EEs 306, 308 or 310. These accumulation and consumption events are correlated (312 and 314) to an RWE 316 wagering or gambling game and potentially the Table Ln-Rc or other RWE parameters, and its use of RC 318 according to formulae and algorithms operating in the GWE, such as functions 318 and 320. The relationship of RC won in the wagering game, and its contribution (322) to EE is also shown in the figure, once again correlated by the GWE via function 324.

One example of EE consumption and accumulation within the hybrid game would be a 1st person shooter game where EE are bullets, and an RWE gambling play for 1 RC would be initiated by the player firing 1 bullet. An RWE play of 1/2 RC (accumulated or rounded) would occur when a player collected each bullet. So, a 2 RC gambling play would occur when a player picks up a clip of 10 bullets found in the game space. In this example, the formulas deployed would be:

EE consumption: bullets fired per pull of the trigger/1=amount of RC wagered

EE accumulation: bullets collected/2=amount of RC wagered

As illustrated in the example above, wagering occurs both when EE is consumed, and when a player collects ammunition.

In another example of EE accumulation triggering RWE play, and an example of the use of a plurality of EE in the Hybrid game, consider the game Scrabble. In this example, one type of EE would be the value of the tiles in a player's tray reduced when they are placed on the Scrabble board (“EE_{VALUE}”). The second type of EE would be the tiles in the tray themselves (“EE_{TILES}”). An EE VALUE consumptive triggering example would be one whereby the RWE gambling game was triggered by the act of placing the tiles on the board for points. For example, placing “Z-O-O” on the board would correspond to the consumption of 12 EE VALUE (Z=10, O=1, O=1), and would correspond to a wager in the RWE game of 6 RC (EE VALUE consumption/2). After playing letters, the player would draw tiles from the bag resulting in an accumulation of EE_{TILES}. In this exemplary game design, each tile drawn, EE_{TILES}, causes an addition 1 RC to be wagered. The illustrative formulas would be:

EE_{VALUE} consumption: value of tiles transferred to the Scrabble board/2=RC wagered

EE_{TILES} accumulation: number of tiles drawn*1=amount of RC wagered

Many permutations of the foregoing example are possible. In another embodiment, the act of consuming EE_{VALUE} by placing tiles would not trigger any RC wagering, but the drawing of tiles from the bag (EE_{TILES} accumulation) would. In yet another embodiment, RC wagered and/or the nature of RWE plays would be consummated and/or adapted based on what the value of the tiles drawn would be (EE_{VALUE} accumulation). Staying with the Scrabble example, the formulas below are a non-exhaustive list of examples on how consumption and accumulation of a plurality of EE might be configured in different embodiments.

Case 1
2 types of EE, EE_{TILES} and EE_{VALUE}
EE_{VALUE} accumulation: 0 RC wagered when value (of tiles) drawn from bag
EE_{VALUE} consumption: 0 RC wagered when value of tiles are placed
EE_{TILES} accumulation: number of tiles drawn*1=RC wagered
EE_{TILES} consumption: 0 RC wagered when tiles are placed

Case 2
2 types of EE, EE_{TILES} and EE_{VALUE}
EE_{VALUE} accumulation: 1 RC wagered*value (of tiles) drawn from bag
EE_{VALUE} consumption: 0 RC wagered when value of tiles are placed
EE_{TILES} accumulation: number of tiles drawn*2=RC wagered on a specific
RWE pay table
EE_{TILES} consumption: 0 RC wagered when tiles are placed

Case 3
1 type of EE, EE_{TILES}
EE_{TILES} accumulation: 0 RC wagered when tiles are drawn
EE_{TILES} consumption: 0 RC wagered when tiles are placed
(note: in this case, RWE wagers are triggered by other means than EE consumption or accumulation)

Case 4
2 types of EE, EE_{TILES} and EE_{BAG} (a new type of EE which is total tiles in the bag, consumption only)
EE_{TILES} accumulation: 0 RC wagered when tiles are drawn
EE_{TILES} consumption: 0 RC wagered when tiles are placed
EE_{BAG} consumption: number of tiles drawn*3=a specific RWE pay table play of 3 RC

In many embodiments, a free bet may be made available for the player. That is to say, in any of the foregoing examples, a wager of 5 RC (for example), could also be a wager of 5 FPRC. “FPRC” means 5 Free Play Real Credits. The mechanism here is that a player wouldn't be charged for 5 FPRC wager, but such a wager, charged off to the casino or free wager provider, would be placed for the player in the RWE. For example, in a first person shooter game, in one embodiment when the trigger is pulled, an EE is consumed (the bullet), and a 1 RC bet is made. If the bet is won, additional EE (bullets) are added to the entertainment game. When the player subsequently pulls the trigger to cause one of these EE to be consumed, 1 RC will again be consumed. In another embodiment, however, when the trigger is pulled, an EE is consumed (the bullet), and a 1 RC bet is made. If the bet is won, (an) additional EE (bullet or bullets) are added to the entertainment game. But these new EE will not require 1 RC to be consumed when they are consumed as a function of subsequent trigger pulls. Rather they will provide a free play of the gambling game as if 1 RC had been committed to the gambling game, but in fact the player's RC will not be decreased. The analogous concept can be applied to actionable elements (more fully described below).

As described above, a relationship exists between EE and RC, so that when RC is won an impact to EE may or may not transpire. In some embodiments a counter relationship is permitted between RC and EE, that is to say, it is also true that when RC is won that EE can be decreased for instance. For example, consider a 1^{st} person adventure game where EE is a measure of toxicity in a GW character's blood. The character has to get the toxicity (EE) down to zero before time runs out and the character dies. Each time the character undertakes an action in the game that causes EE to increase a gambling game is initiated, causing RC to be consumed. If the gambling game is won RC is increased and the character's EE is decreased. In this way, various embodiments subsume all manner of relationships between RC and EE, a number of which, not meant to be exhaustive, are listed below.
Accumulation of EE can cause a consumption of RC, and any subsequent increase in RC as a function of a gambling win can cause EE to accumulate.
Accumulation of EE can cause a consumption of RC, and any subsequent increase in RC as a function of a gambling win can cause EE to decrease.
Consumption of EE can cause a consumption of RC, and any subsequent increase in RC as a function of a gambling win can cause EE to accumulate.
Consumption of EE can cause a consumption of RC, and any subsequent increase in RC as a function of a gambling win can cause EE to decrease.

In certain embodiments, GWC accumulation or consumption trigger RWE wagers in the same manner in which EE accumulation or consumption does. Noting that GWC accumulation and consumption will loosely correlate to EE consumption or accumulation as reflected in the ESE entertainment game, so it should be noted that nothing precludes all aforementioned relationships of EE accumulation and consumption from working in a similar manner in a hybrid game.

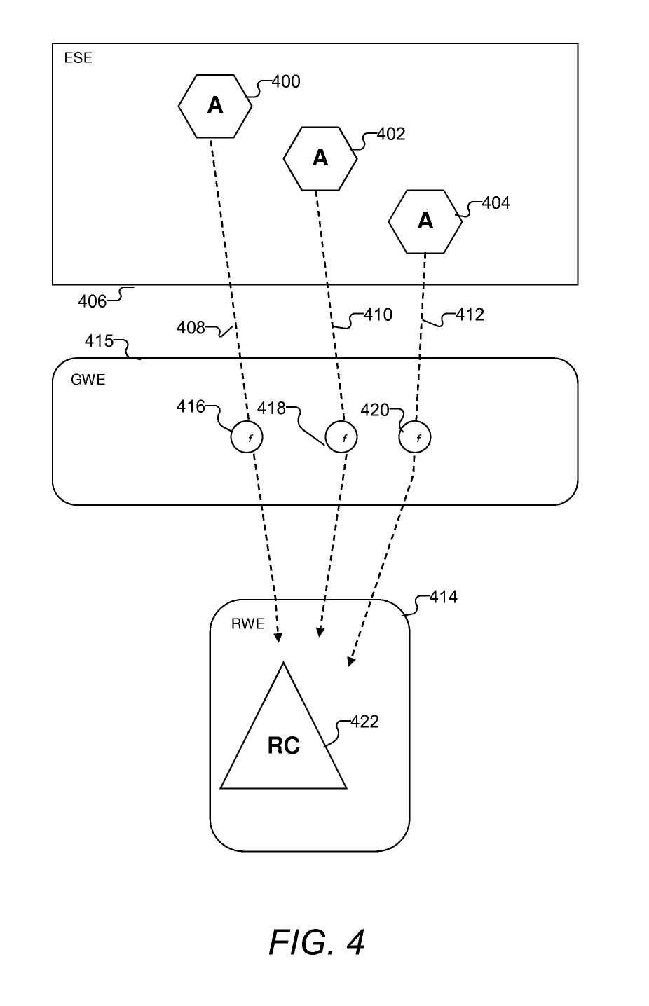

FIG. 4 is a diagram of a process of using actionable elements in accordance with exemplary embodiments. In FIG. 4, AE's 400, 402, and 404 within the ESE 406 entertainment/skill game are shown. In the figure, when an AE transpires, a trigger (408, 410 or 412) of an RWE 414 gambling game results, the occurrence of which and the size and nature of the wager being controlled by various formulae and algorithms (416, 418 or 420 respectively) operating in a GWE 415. As seen in the diagram, there may be one, none or a plurality of AEs operating in the hybrid game construct. Since the nature of the correlation of an AE to RC 422 is under control of the GWE, the relationship between them may be linear or non-linear, and may vary based on what play level the game is operating at, the amount of time that game has been play, the amount of GWC a player has, and a number of other possible factors. In FIG. 4, the relationship is that of AE causing RWE action and thus impact to the RC, and is not a bi-directional relationship. This is to say that the accumulation of RC, through winning the gambling game or putting additional credits in the machine does not affect AE. The relationship between AE and RC is causal from the direction of AE to RC, that is the completion of an AE event initiates the execution of a gambling game with a specified amount of RC.

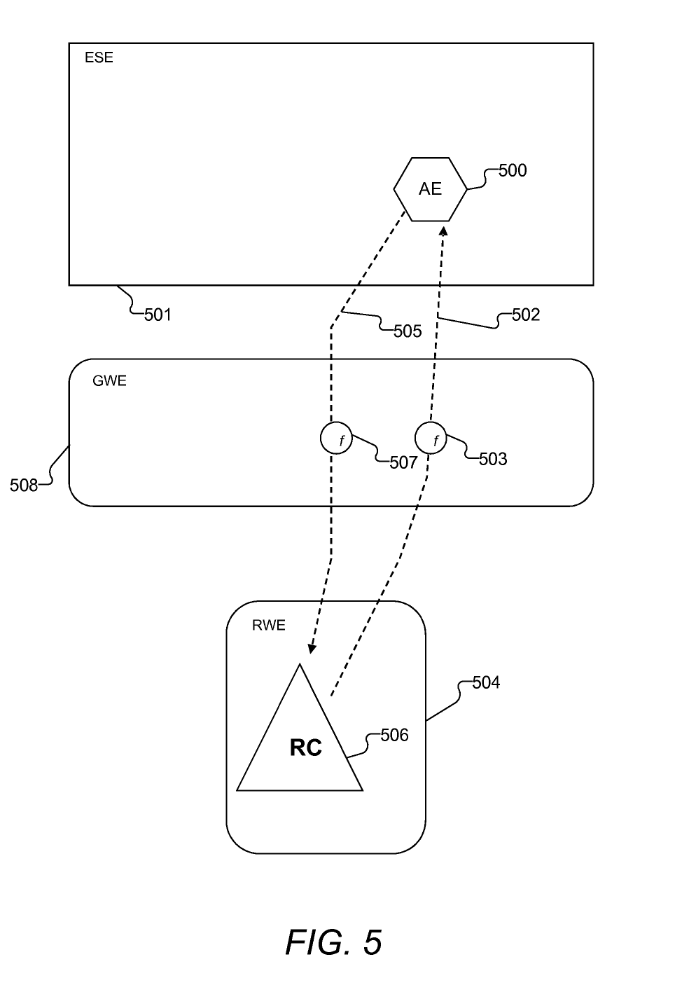

FIG. 5 is a diagram of a process of revealing actionable elements in accordance with exemplary embodiments. FIG. 5 shows another use of AE in various embodiments of a hybrid game. In this diagram, an AE 500 illustrates that exposure to AE within an ESE 501 may be created or modified (502) as a function 503 of a gambling outcome or result from an RWE 504, or as a result of a consumption or accumulation of RC 506. As shown in the diagram, a GWE 508 would control this capability as may be appropriate for the entertainment/skill game type, the amount being wagered, etc. A practical example of this might be that upon a jackpot won resulting in a large amount of RC gained, the GWE would instruct the ESE to establish a special goal for the player in the entertainment/skill game as a bonus award, such as creating a treasure chest that the player encounters, providing a trivia question for the player to answer, or provide a room with doors available for opening all of which are opportunities for decisions or actions provided for the player in the game space, thus making them, upon player interaction with same, AEs. Note that since the GWE controls the correlation of AE to the RWE, and in this embodiment, RC/RWE created an opportunity to undertake an AE event, the permutations of how AE could be introduced and the feedback loops 505 and functions 507 possible are effectively limitless. The practical application of this feedback loop of created and then transpired AE would be typically determined by the context of the game in question, player entertainment value, regulatory requirements, and the financial considerations for the casino operator.

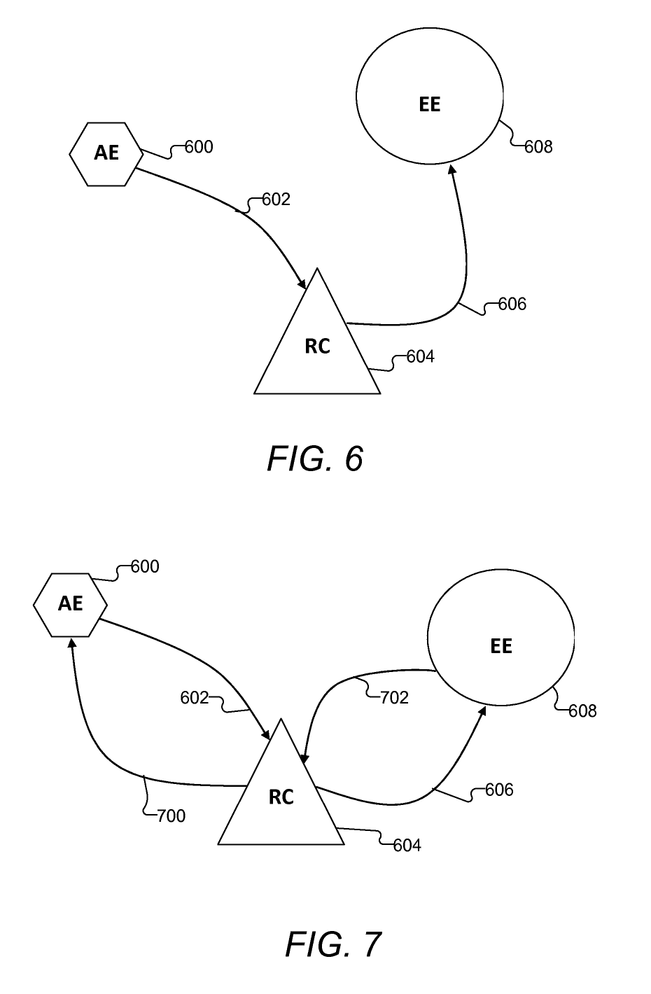

FIG. 6 is a diagram of a process of using actionable and enabling elements in accordance with exemplary embodiments. It should be noted that a relationship can exist between AE and EE as a function of RC in certain embodiments of a hybrid game. FIG. 6 demonstrates such a relationship. In FIG. 6, an AE 600 transpiring triggers (602) a wager impacting RC 604, which can in turn impact (606) EE 608 (as is consistent with the nature of the interrelationship between RC and EE in the hybrid game).

FIG. 7 is another diagram of a process of using actionable and enabling elements in accordance with exemplary embodiments. FIG. 7 is similar to FIG. 6, but feedback loops 700 and 702 between RC 604 and each of AE 600 and EE 608 (respectively) are shown as is consistent with the hybrid game construct and the foregoing descriptions of the various embodiments.

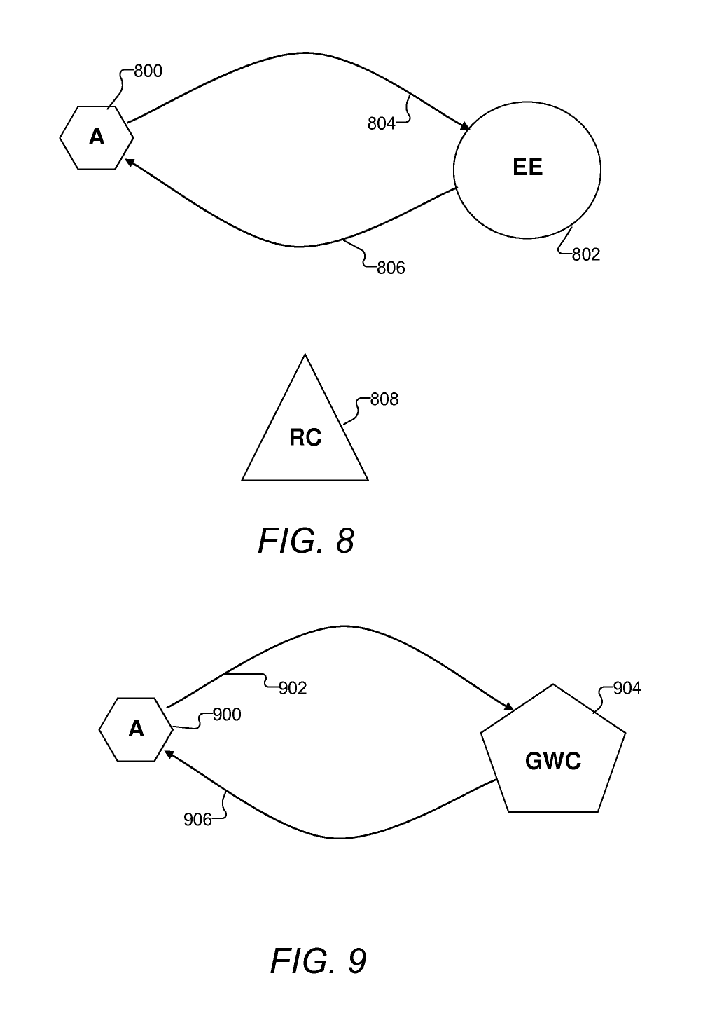

FIG. 8 is another diagram of a process of using actionable and enabling elements in accordance with exemplary embodiments. FIG. 8 shows the addition of an interrelationship between an AE 800 and an EE 802 directly. The diagram is meant to imply that an AE event could result in a direct impact (804) to EE, without necessarily involving an RC 808 wager. An example of which would be in a shooter game, opening a locked ammo can at night, subject to the game characters dexterity, knowledge and night vision, the success of which would make additional ammo available to the character. FIG. 8 also illustrates a feedback (806) from EE to AE whereby consumption or accumulation of EE might impact or create an AE or plurality of AEs. An example of which would be that the character in a shooter game might accumulate enough gas grenades (the EE), and a bunker with 2 doors, one of which would leak enough for the grenades to be effective, may be established for the player to use the grenades on (the AE being the player's choice as to which door to throw the grenades at).

In certain embodiments, there may be a relationship between AE and GWC as illustrated in FIG. 9. The nature of this relationship would be that an AE 900 transpiring or an AE outcome may cause an accrual or declination (902) of GWC 904. Conversely, it is also possible in certain embodiments that attaining a sufficient amount of GWC, opportunities for the player to exercise (906) an AE may be created or deleted in the game space with all the implications, benefits and playability aspects that could be the resultant. One example of this might be that a player may need to make a decision (the AE) between selecting between 3 fighter aircraft for their character to board to enter a dogfight. The act of making a decision of an aircraft which would be more suitable to the player's pilot's dexterity and aggressiveness characteristics than another would cause GWC to accrete to the player's total GWC.

In some embodiments, when an AE transpires, in addition to causing a specific amount of RC to be wagered, it may in full or in part specify the nature of the gambling game by affecting odds and pay table selection. This is to say that in the case where there may be several AE in a game, each AE may have its own unique wagering proposition in terms of the wager size, odds, possible jackpots and possibly entry into a larger progressive or community wagering pool.

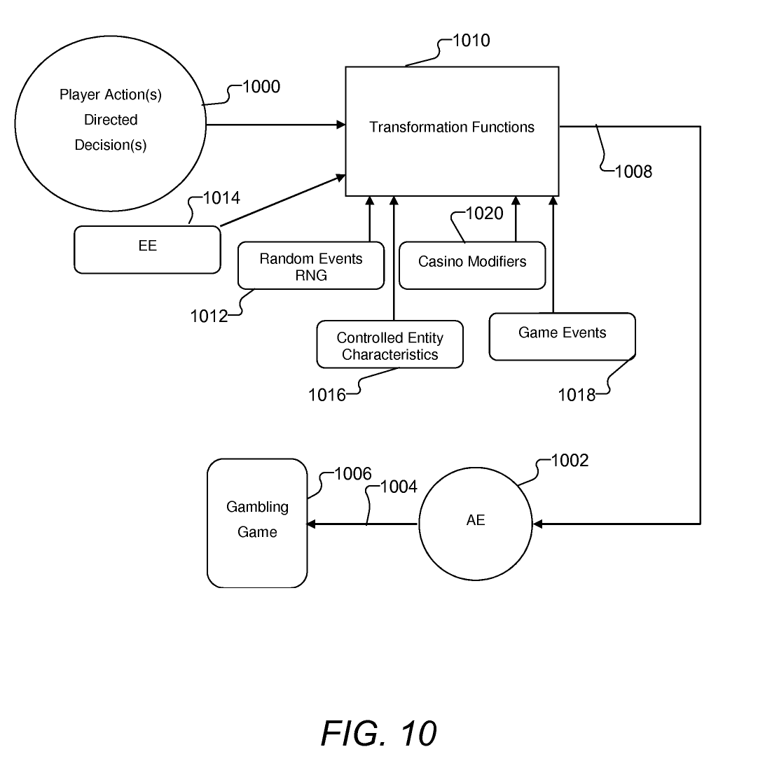

FIG. 9 is another diagram of a process of using actionable and enabling elements in accordance with exemplary embodiments. FIG. 10 illustrates the correlation a player action 1000 in the PW, to an AE 1002 transpiring (1004) resulting in an RWE wager in a gambling game 1006 and intervening controls on the process. This figure illustrates that it is possible for a player action to invoke (1008) an AE that in turn will trigger a gambling game within the RWE. In some embodiments, the player actions can be one of decision making and/or directing certain controlled entity actions. These decisions and directed actions may involve a player's knowledge, a player's skill, both or neither. In FIG. 10, the player action or directed decision is conditioned by one or more transformation functions 1010 that take as arguments, the player action itself, and a plurality of other inputs as player action modifiers (PAMs). These inputs can include, but are not limited to; random events within the entertainment game, EE 1014 (e.g. health points), GW controlled entity characteristics 1016, entertainment game events 1018, other entertainment game related variables (not shown), casino driven inputs 1020, etc. The output of the transformation functions gives rise to the AE transpiring in the entertainment game, which then triggers a gambling game as previously described.

In many embodiments, this process—the causality between the occurrence of an AE and the execution of a gambling game—may also be conditioned by a second set of transformation functions, which can take as input the same, a different set, or a partially coincident set of conditioning inputs.

An example of one embodiment would be a racing game. The player action would be steering the car, which would be a skill-based action. The AE is the distance traveled by the car around the track, specifically in this case, once around the track. Each time around the track is equivalent to one AE, which causes one RC to be bet in a gambling game. AE transpiring in this example (i.e. each lap around the track), however, is not just a function of user's skill driving the car. Prior to the start of the race itself, but within the context of the entertainment game, the player had the opportunity to select various attributes for his race car in the game. He could choose from a menu of options, including stickier tires, a faster engine, higher maneuverability, the ability to sustain more damage and so on. After choosing one or a number of these features (which may or may not require the consumption of RC, GWC or some other form of currency in the game), the race commences. The player steers the car, and in response to that input, along with the state of game variables set by the choices made around the car's features by the player (the PAMs in this case), the transformation functions establish the pace at which the car precedes around the track, making the car's progress, and by extension the amount of AE that transpires a function not only of the player's skill, but also the characteristics of the car and random events such as whether or not the car suffers a blown tire, its tires hit some oil on the road and break loose, etc.

A second example concerns a first person shooter game. In this game, the player action is the act of raising a gun, aiming it carefully at a target on the screen and pulling the trigger. The PAMs in this example include the Marksmanship and Dexterity scores of the player's Controlled Entity within the game, the type of scope on the weapon, the player Controlled Entity's health points (a form of EE in this example) so he can hold the rifle steady, and the amount of wind. These PAMs, plus the skill with which the player aimed the gun and held it steady while firing, are used by the Transformation Functions to establish whether or not the shot fired hits the intended target (the transpiring of an AE). If the target is hit, the AE transpires, and a bet is made in the gambling game.

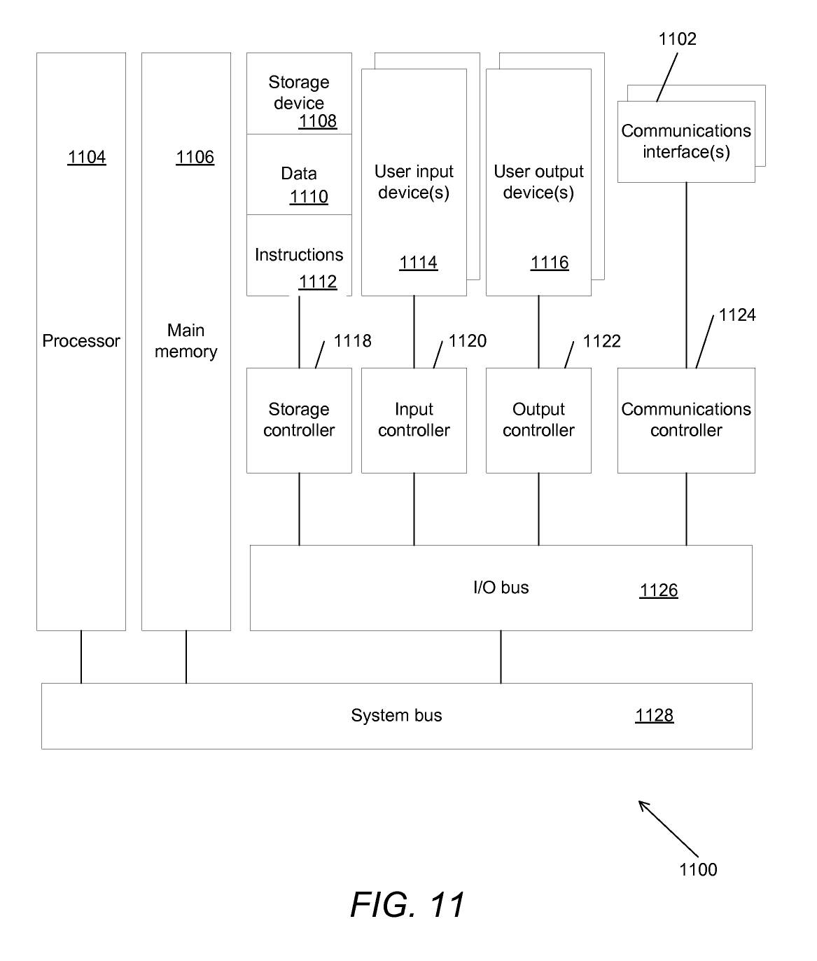

FIG. 11 is a hardware architecture diagram of a processing apparatus in accordance with exemplary embodiments. Any of a variety of processing apparatuses can host various components of a hybrid gaming system in accordance with various embodiments of the invention. In several embodiments, these processing apparatuses can include, but are not limited to, a gaming machine, a general purpose computer, a computing device and/or a controller. In the processing apparatus 1100, a processor 1104 is coupled to a memory 1106 by a bus 1128. The processor 1104 is also coupled to non-transitory processor-readable storage media, such as a storage device 1108 that stores processor-executable instructions 1112 and data 1110 through the system bus 1128 to an I/O bus 1126 through a storage controller 1118. The processor 1104 is also coupled to one or more interfaces that may be used to connect the processor to other processing apparatuses as well as networks as described herein. The processor 1104 is also coupled via the bus to user input devices 1114, such as tactile devices like keyboards, keypads, foot pads, touch screens, trackballs, etc., as well as non-contact devices such as audio input devices, motion sensors and motion capture devices, etc. that the processing apparatus may use to receive inputs from a user when the user interacts with the processing apparatus. The processor 1104 is connected to these user input devices 1114 through the system bus 1128, to the I/O bus 1126 and through the input controller 1120. The processor 1104 is also coupled via the bus to user output devices 1116 such as (but not limited to) visual output devices, audio output devices, and/or tactile output devices that the processing apparatus uses to generate outputs perceivable by the user when the user interacts with the processing apparatus. In several embodiments, the processor is coupled to visual output devices such as (but not limited to) display screens, light panels, and/or lighted displays. In a number of embodiments, the processor is coupled to audio output devices such as (but not limited to) speakers, and/or sound amplifiers. In many embodiments, the processor is coupled to tactile output devices like vibrators, and/or manipulators. The processor is connected to output devices from the system bus 1128 to the I/O bus 1126 and through the output controller 1122. The processor 1104 can also be connected to a communications interface 1102 from the system bus 1128 to the I/O bus 1126 through a communications controller 1124.

In various embodiments, a processor loads the instructions and the data from the storage device into the memory and executes the instructions and operates on the data to implement the various aspects and features of the components of a hybrid gaming system as described herein. The processor uses the user input devices and the user output devices in accordance with the instructions and the data in order to create and operate user interfaces for players, casino operators, owners, etc. as described herein.

Although the processing apparatus is described herein as being constructed from a processor and instructions stored and executed by hardware components, the processing apparatus can be composed of only hardware components in accordance with many embodiments. In addition, although the storage device is described as being coupled to the processor through a bus, those skilled in the art of processing apparatuses will understand that the storage device can include removable media such as a USB memory device, an optical CD ROM, magnetic media such as tape or disks, etc. Also, the storage device can be accessed through one of the interfaces or over a network. Furthermore, any of the user input devices or user output devices can be coupled to the processor via one of the interfaces or over a network. In addition, although a single processor is described, those skilled in the art will understand that the processor can be a controller or other computing device or a separate computer as well as be composed of multiple processors or computing devices.

In numerous embodiments, any of a hybrid game including an RWE, a GWE and an ESE as described herein can be implemented on one or more processing apparatuses, whether dedicated, shared or distributed in any combination thereof, or may be implemented on a single processing apparatus. In addition, while certain aspects and features of a gaming system described herein have been attributed to an RWE, a GWE or an ESE, these aspects and features may be implemented in a hybrid form where any of the features or aspects may be performed by any of a RWE, a GWE or an ESE within a gaming system without deviating from the spirit of the invention.

While the above description contains many specific embodiments of the invention, these should not be construed as limitations on the scope of the invention, but rather as examples of embodiments thereof. It is therefore to be understood that the invention may be practiced otherwise than as specifically described, without departing from the scope and spirit of the invention. Thus, the described embodiments of the invention should be considered in all respects as illustrative and not restrictive.

1. A method of a gaming system, comprising:
receiving by the gaming system a real world credit;
enabling by the gaming system a gambling game portion of the gaming system that consumes the real world credit;
creating by the gaming system an element for an entertainment game portion of the gaming system, the element utilized during operation of the entertainment game portion by a player; and
correlating by the gaming system the real world credit with the element of the entertainment game portion by:
determining a transpiring of the element in the entertainment game portion of the gaming system;
initiating a wager of the real world credit in the gambling game portion of the gaming system based on the transpiring of the element in the entertainment game portion of the gaming system; and
affecting by the gaming system the entertainment game portion of the gaming system based on an outcome of the wager of the real world credit in the gambling game portion of the gaming system.

2. The method of claim 1, wherein the transpiring of the element includes accumulation of an enabling element that is consumed by the player's operation of the entertainment game portion of the gaming system.

3. The method of claim 1, wherein the transpiring of the element includes transpiring of a game meter tick.

4. The method of claim 3, wherein the game meter tick is an increment of elapsed physical time that has elapsed.

5. The method of claim 3, wherein the game meter tick is an increment of elapsed game world context time that has elapsed.

6. The method of claim 3, wherein the game meter tick is a game world context distance traveled

7. The method of claim 3, wherein the game meter tick is a game world context location.

8. The method of claim 3, wherein the game meter tick is an arrival at a game world context location.

9. The method of claim 1, wherein the transpiring of the element includes a decision made by a player of the gaming system directing a resource within the game world.

10. The method of claim 1, wherein the transpiring of the element includes a game world outcome of a decision made by the player directing a resource within the game world.

11.-18. (canceled)

19. An apparatus for gaming, comprising:
a processor; and
a memory coupled to the processor, the memory having processor-executable instructions stored therein, the processor-executable instructions comprising:
receiving by the gaming system a real world credit;
enabling by the gaming system a gambling game portion of the gaming system that consumes the real world credit;
creating by the gaming system an element for an entertainment game portion of the gaming system, the element utilized during operation of the entertainment game portion by a player; and
correlating by the gaming system the real world credit with the element of the entertainment game portion by:
determining a transpiring of the element in the entertainment game portion of the gaming system;
initiating a wager of the real world credit in the gambling game portion of the gaming system based on the transpiring of the element in the entertainment game portion of the gaming system; and
affecting by the gaming system the entertainment game portion of the gaming system based on an outcome of the wager of the real world credit in the gambling game portion of the gaming system.

20. The apparatus of claim 19, wherein the transpiring of the element includes accumulation of an enabling element that is consumed by the player's operation of the entertainment game portion of the gaming system.

21. The apparatus of claim 19, wherein the transpiring of the element includes transpiring of a game meter tick.

22. The apparatus of claim 21, wherein the game meter tick is an increment of elapsed physical time that has elapsed.

23. The apparatus of claim 21, wherein the game meter tick is an increment of elapsed game world context time that has elapsed.

24. The apparatus of claim 21, wherein the game meter tick is a game world context distance traveled

25. The apparatus of claim 21, wherein the game meter tick is a game world context location.

26. The apparatus of claim 21, wherein the game meter tick is an arrival at a game world context location.

27. The apparatus of claim 21, wherein the transpiring of the element includes a decision made by a player of the gaming system directing a resource within the game world.

28. The apparatus of claim 21, wherein the transpiring of the element includes a game world outcome of a decision made by the player directing a resource within the game world.

29.-36. (canceled)

37. A processor-readable storage medium having stored processor-executable instructions, the processor-executable instructions comprising:
receiving by the gaming system a real world credit;
enabling by the gaming system a gambling game portion of the gaming system that consumes the real world credit;
creating by the gaming system an element for an entertainment game portion of the gaming system, the element utilized during operation of the entertainment game portion by a player; and
correlating by the gaming system the real world credit with the element of the entertainment game portion by:
determining a transpiring of the element in the entertainment game portion of the gaming system;
initiating a wager of the real world credit in the gambling game portion of the gaming system hybrid game based on the transpiring of the element in the entertainment game portion of the gaming system; and
affecting by the gaming system the entertainment game portion of the gaming system based on an outcome of the wager of the real world credit in the gambling game portion of the gaming system.

38. The processor-readable storage medium of claim 37, wherein the transpiring of the element includes accumulation of an enabling element.

39. The processor-readable storage medium of claim 37, wherein the transpiring of the element includes transpiring of a game meter tick.

40. The processor-readable storage medium of claim 39, wherein the game meter tick is an increment of elapsed physical time that has elapsed.

41. The processor-readable storage medium of claim 39, wherein the game meter tick is an increment of elapsed game world context time that has elapsed.

42. The processor-readable storage medium of claim 39, wherein the game meter tick is a game world context distance traveled

43. The processor-readable storage medium of claim 39, wherein the game meter tick is a game world context location.

44. The processor-readable storage medium of claim 39, wherein the game meter tick is an arrival at a game world context location.

45. The processor-readable storage medium of claim 39, wherein the transpiring of the element includes a decision made by a player of the gaming system directing a resource within the game world.

46. The processor-readable storage medium of claim 39, wherein the transpiring of the element includes a game world outcome of a decision made by the player directing a resource within the game world.

47.-54. (canceled)
